(19) United States
(12) Patent Application Publication
(10) Pub. No.: US 2005/0154814 A1
(43) Pub. Date: Jul. 14, 2005

(54) Bus configuration based on card location

(76) Inventors: Sung H. Kuo, Houston, TX (US); Alan M. Green, Tomball, TX (US); Shawn C. Bish, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/756,903

(22) Filed: Jan. 14, 2004

(51) Int. Cl. G06F 13/00

(52) U.S. Cl. 710/302; 710/306

(57) ABSTRACT

A system comprises a bridge, a logic device, and a plurality of slots. The slots couple to the bridge via a bus segment and to the logic device. Each slot may be capable of receiving an add-in card. The logic device determines whether a card is installed in any of the slots and, if a card is installed in a slot, the logic device determines in which slot the card is installed. The logic device further causes the bridge to configure the bus segment based on location of cards, if any, in the slots.

### BACKGROUND

Some electronic systems, such as computers, include one or more busses to which one or more electronic devices connect. Typically, a bridge device connects to a bus to permit devices connected to the bus to communicate with other devices in the system. Some computers permit one or more circuit cards to be installed in the computer to connect to a bus associated with the computer. Such cards are referred to as “add-in” cards for purposes of this disclosure.

Busses are generally implemented in accordance with a particular protocol. Examples of such protocols include Universal Serial Bus (“USB”), Peripheral Component Interconnect (“PCI”) and Peripheral Component Interconnect Extended (“PCI-X”). An add-in card designed in accordance with one protocol may or may not be compatible with a bus designed in accordance with another protocol. Further, add-in cards of one protocol may be capable of operating at a different frequency than add-in cards of another protocol. In general, the add-in cards permitted to be connected to a particular bus are all operated at the same frequency and in accordance with the same protocol.

Some add-in cards may be operated at a particular frequency that permits only one card to be installed on a bus. For example, only one PCI-X card can be installed on a PCI-X bus if a 266 MHz speed is desired. If a user, however, desires to have more than one PCI-X card operating on a given bus, each card is operated at a lower frequency (e.g., 100 MHz). Implementing a system that can permit slower or faster cards to be installed may require multiple bridge devices and multiple busses. One bus may be implemented for operation of a single, faster (e.g., 266 MHz) card, while another bus may permit multiple cards operating at a slower speed (e.g., 100 MHz). Flexibility in such systems is achieved at the expense of additional hardware, namely, additional bridges, busses and associated electronics.

### BRIEF SUMMARY

In accordance with at least some embodiments of the invention, a system comprises a bridge, a logic device, and a plurality of slots. The slots couple to the bridge via a bus segment and to the logic device. Each slot may be capable of receiving an add-in card. The logic device determines whether a card is installed in any of the slots and, if a card is installed in a slot, the logic device determines in which slot the card is installed. The logic device further causes the bridge to configure the bus segment based on location of cards, if any, in the slots.

### BRIEF DESCRIPTION OF THE DRAWINGS

For a detailed description of some embodiments of the invention, reference will now be made to the accompanying drawings in which:

FIG. 1 shows a system configured in accordance with an embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to.” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

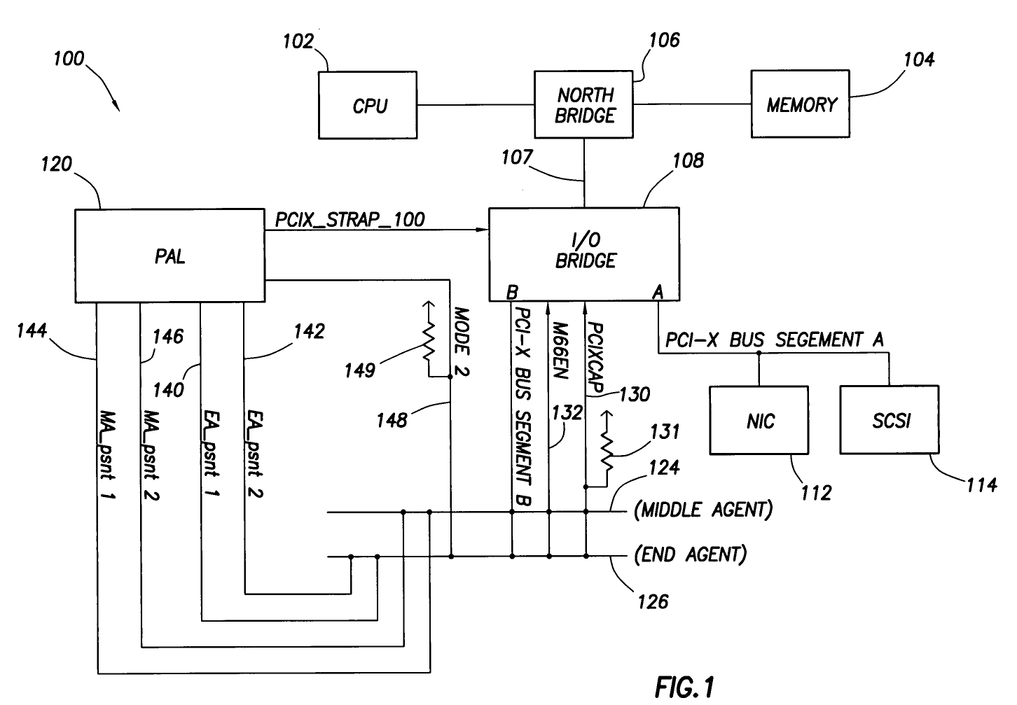

Referring now to FIG. 1, a system 100 is shown in accordance with an exemplary embodiment of the invention. As shown, system 100 comprises a central processing unit (“CPU”) 102 and memory 104 coupled to a “north” bridge device 106. An input/output (“I/O”) bridge 108 also couples to the north bridge 106 via an Interconnect bus 107. The system 100 further provides a pair of PCI-X bus segments A and B for connection to various devices. Examples of such devices connected to PCI-X bus segment A include a network interface controller (“NIC”) 112 and a small computer system interface (“SCSI”) 114.

A pair of add-in card slots 124 and 126 also couple to the I/O bridge 108. Each slot comprises a connection socket into which an add-in card may be inserted for connection to the system 100. As shown in FIG. 1, the PCI-X Bus Segment B is electrically connected first to slot 124 and then to slot 126. In this configuration, slot 126 is referred to as the “end agent slot” or “end agent” and slot 124 is referred to as the “middle agent slot” or “middle agent.”

System 100 also comprises logic device 120 such as a programmable array logic (“PAL”). The PAL 120 couples to the I/O bridge 108 and to the middle and end agent slots 124 and 126. The PAL 120 contains a plurality of gates configured to perform the functionality described herein. The PAL 120 and I/O bridge 108 function, at least in part, to determine which cards, if any, are installed in slots 124, 126. To the extent that only one card is installed in the system, the PAL 120 determines into which of the slots 124 or 126 the single card is installed. Based on a determination of the card location, the bridge 108 is adapted to configure the PCI-X bus segment B to ensure proper system behavior. Configuring the PCI-X bus segment may include selecting an appropriate clock frequency from a plurality of selectable clock frequencies for the bus and/or selecting an appropriate voltage for use on the bus from a plurality of selectable voltages.

By way of example, a PCI-X card may be operated at a higher speed (e.g., 266 MHz versus 66 MHz) only if only one such PCI-X card is installed on a PCI-X bus segment and that sole card is located in the end agent slot 126, not the middle agent slot 124. Thus, if a PCI-X capable card is installed in the end agent slot 126 and the middle agent slot 124 is vacant, the PCI-X bus segment B can be configured to operate at a first predetermined speed if the sole PCI-X capable card is so capable. The first predetermined speed may be, for example, 266 MHz or 533 MHz. If, however, the same card is installed in the middle agent slot 124, instead of the send agent slot 126, then the PCI-X bus segment B may not be configured for the first predetermined speed; rather, the PCI-X bus segment B is configured to operate at a second lower predetermined speed. The second lower predetermined speed may be, for example, 33 MHz, 66 MHz, or 100 MHz. Continuing this example, if both slots 124 and 126 are occupied with add-in cards, then the PCI-X bus segment B is configured to operate at the second lower predetermined speed, even if one or both cards are capable of operating at the higher first predetermined speed. This speed limitation on the bus segment, in which cards located in the middle agent slot limit the bus to lower frequencies, results from loading and other known effects that otherwise may occur. An appropriate I/O voltage also may be set for the bus segment to ensure proper bus segment operation.

The coordinated action of the I/O bridge 108 and the PAL 120 also configures the PCI-X bus segment B taking into account the types of cards that may be installed in the middle and end agent slots 124, 126. For example, although a card is installed only in the end agent slot 126, the bridge 108 may configure the bus segment B to a 66 MHz bus if the sole card installed in slot 126 is only 66 MHz-capable. Further, the PAL 120/bridge 108 configure the PCI-X bus segment B generally based on the lowest common denominator operational frequency of cards installed in the slots 124, 126 and the location of such cards in those slots. That is, the PAL 120 and bridge 108 function to ensure proper bus segment behavior given the card(s) that may be installed in the slots and the location of the cards in those slots. This functionality permits a user to achieve higher performance if the user installs only a single card in the end agent slot 126, while also affording flexibility if the user desires to install multiple cards on a PCI-X bus segment.

Various signals are shown in FIG. 1 and will now be described. A card installed in a slot alters the voltage on the PCIXCAP signal line 130 to indicate the type of PCI or PCI-X card that is installed. The PCIXCAP signal line 130 is electrically shared by both slots 124 and 126. The system board (not specifically shown) on which some or all of the components shown in FIG. 1 are installed includes a pull-up resistor 131 on the PCIXCAP signal line 130. An add-in card may include a particular termination for the PCIXCAP signal to alter the voltage of the PCIXCAP signal and thereby indicate the card type to the I/O bridge 108. The various types of add-in card terminations to indicate card types are provided in the PCI-X specification. For example, a “conventional” PCI card (i.e., a PCI-compliant card that does not comport with the PCI-X standard) ties the PCIXCAP signal line 130 to ground thereby forcing the PCIXCAP signal to 0 volts (logic low). A PCI-X 133 MHz card provides a 0.01 microfarad capacitor connected between the PCIXCAP signal and ground. A capacitor represents an open circuit at direct current (“DC”) voltage. As a result, the signal level on the PCIXCAP signal line 130 will be a logic high. PCI-X 66 MHz cards include a 10 kohm pull down resistor. PCI-X 266 MHz and 533 MHz cards include a 3.16 kohm and 1.02 kohm resistor, respectively, connected between the PCIXCAP signal line 130 and a transistor that is turned on and off by the “mode 2” signal 148 (described below). Each card installed in a slot 124 or 126 thus alters the voltage level on the PCIXCAP signal line 130. The I/O bridge 108 detects the voltage level on the PCIXCAP signal line 130 to determine the card type(s) installed in the system. Based only on the PCIXCAP signal line 130, the I/O bridge cannot determine card location, that is, which slot 124 or 126 contains which card. Instead, and as explained below, the PAL 120 determines card location.

The M66EN signal line 132 also is electrically shared and asserted by cards that may be installed in the slots 124 and 126. The M66EN signal indicates whether, if the card is a conventional PCI card, the card can be operated at 66 MHz or should be operated at 33 MHz. If the M66EN signal is not asserted and the card is a conventional PCI card, the card should be operated at 33 MHz. If, however, the M66EN signal is asserted and the card is a conventional PCI card, the card can be operated at 66 MHz.

Each slot 124 and 126 provides a pair of presence signals (bits) to the PAL 120. The end agent slot 126 provides a pair of presence bits EA_psnt1 140 and EA_psnt2 142. The middle agent slot 124 provides a pair of presence signals MA_psnt1 144 and MA_psnt2 146. The presence signals for each slot encode whether a card is present in the associated slot as well as the power requirements for the card. If the slot is vacant, both presence signals will be at logic high levels (“11”). If a card is present in the slot, at least one presence signal will be at a logic low level (i.e., the presence signals will be “10,” “01,” or “00”) to encode different power requirements (e.g., 5 W, 10 W or 25 W). The PAL 120 receives the presence signals and determines whether either or both presence bits from a slot are a 0. If at least one of the presence bits is a 0, the PAL 120 determines that a card is installed in the slot. The PAL 120 examines the presence bits associated with both slots to determine which slots have cards installed therein. As such, the PAL 120 is able to determine if only the end agent slot 126 has a card, only the middle agent slot 124 has a card, neither slot has a card, or both slots have cards.

PCI-X bus segments can be operated in “mode 1” or “mode 2.” PCI-X mode 2 refers to a mode in which a PCI-X bus segment is able to operate at higher speeds than for mode 1. Per the PCI-X specification, the fastest speed attainable under mode 2 is 266 MHz for double data rate, or 533 MHz for quad data rate. With mode 1, the fastest speed attainable is 133 MHz. These maximum speeds are permitted only if a card is installed in the end agent slot 126 and the middle agent slot is unoccupied. For a PCI-X bus segment to operate in mode 2, both the card and the bridge 108 must be mode 2 capable. The mode 2 signal 148 couples to the PAL 120 and to end agent slot 126. A pull-up resistor 149 normally pulls the mode signal high. A logic low state for the mode 2 signal indicates that the system is not to operate in mode 2.

A card installed in the middle agent slot 124 is not permitted to operate in mode 2. As such, the mode 2 pin on the middle agent slot is grounded by the system board to prevent a card in the middle agent slot from operating in mode 2. If a card installed in the end agent slot 126 is mode 2 capable and the middle agent slot 124 is unoccupied, the PAL 120 determines that there is one card installed in the end agent and does not ground the mode 2 signal, thereby allowing the PCIXCAP signal to take on a mode 2 voltage. If a card is installed in the end agent slot only and is not mode 2 capable, then such a card grounds the mode 2 signal. If, at any time, a card is installed in the middle agent slot 124, the PAL 120 grounds the mode 2 signal to the end agent slot 126 preventing a card in the end agent slot from signaling a mode 2 capable voltage on the PCIXCAP signal. If the system 100 (e.g., the I/O bridge 108) is not capable of mode 2 operation, the PAL 120 or bridge 108 pulls the mode 2 signal low to signal any mode 2 capable add-in cards that such cards may not operate in mode 2.

The PCIX_STRAP_100 signal interconnects the PAL 120 and the I/O bridge 108. The PAL 120 asserts the PCIX_STRAP_100 signal when the PCI-X bus segment should not be operated in mode 2 and should be operated at 100 MHz. For example, the PAL 120 asserts the PCIX_STRAP_100 signal upon detection of an add-in card in the middle agent slot 124.

The PAL 120 generally determines whether any cards are installed in the system and, if so, which slots have cards so installed. Based on that information, the PAL 120 asserts, or not, the PCIX_STRAP_100 signal. As explained above, the PAL 120 asserts the PCIX_STRAP_100 signal if the PAL determines that a card is present in the middle agent slot 124 which precludes the faster 266 MHz or 533 MHz bus speeds (mode 2) or 133 MHz (mode 1). The bridge 108 monitors the PCIXCAP and M66EN signals 130, 132 to determine the types of cards installed in the slots 124, 126 to correctly configure the bus.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
a bridge;
a logic device; and
a plurality of slots coupled to the bridge via a bus segment and to the logic device, each slot being capable of receiving an add-in card;
wherein the logic device determines whether a card is installed in any of the slots and, if a card is installed in a slot, the logic device determines in which slot the card is installed and causes the bridge to configure the bus segment based on location of cards, if any, in the slots.

2. The system of claim 1 wherein the logic device comprises a programmable logic device.

3. The system of claim 1 wherein the logic device receives presence signals associated with each slot, the presence signals for a particular slot encode whether or not a card is present in that particular slot.

4. The system of claim 1 wherein each add-in card comports with any of a plurality of card types and the bridge configures the bus segment based on card type as well as location of cards.

5. The system of claim 1 wherein the bridge configures the bus segment by selecting one of a plurality of selectable clock frequencies for the bus segment.

6. The system of claim 1 wherein the bridge configures the bus segment by selecting a higher clock frequency if a card is installed in a predetermined slot and no other cards are installed in other slots or by selecting a lower clock frequency if a plurality of cards are installed in the slots or only a single card is installed in a slot other than the predetermined slot.

7. The system of claim 5 wherein the bridge also configures the bus segment by causing one of a plurality of selectable voltage levels to be applied to the bus segment.

8. The system of claim 1 wherein the bridge configures the bus segment by causing one of a plurality of selectable voltage levels to be applied to the bus segment.

9. The system of claim 1 wherein the bus segment is a PCI-X bus segment.

10. A logic device that contains a plurality of gates configured to receive presence signals from a plurality of slots into which add-in cards may be installed, the presence signals indicating whether a card is installed in a particular slot, the logic device's gates are further configured to cause a bridge device to configure a clock frequency of a bus segment based on slot location for the installed cards.

11. The logic device of claim 10 wherein the slots comprise a middle agent slot and an end-agent slot, the middle agent slot being electrically disposed between the bridge and the end agent slot, and the gates of the logic device are further configured to individually determine whether add-in cards are installed in the end agent slot and the middle agent slot.

12. A bridge device that contains a plurality of gates adapted to configure a bus segment based on a type of card installed on said bus segment and based on location of said card on said bus segment.

13. The bridge device of claim 12 wherein the bridge device is configured to couple to a logic device, and wherein the bridge device receives a signal from the logic device that causes the bridge device to configure the bus segment at speed that is lower than a rated speed of said card.

14. The bridge device of claim 13 wherein said bridge device receives a plurality of signals from slots into which a plurality of cards can be installed, said plurality of signals are indicative of types associated with cards that can be installed in said slots.

15. A system, comprising:
a bridge;
a plurality of slots coupled to the bridge via a bus segment, each slot being capable of receiving an add-in card; and
means for determining whether one or more cards are installed in any of the slots and, if one or more cards are installed in a slot or slots, for determining in which slot or slots the one or more cards are installed and for causing the bridge to configure the bus segment based on card location.

16. The system of claim 15 further comprising means for determining if a card is installed in a predetermined slot and, if so, for causing the bridge to configure the bus segment to operate at a speed that is lower than the rated speed at least one installed card.

17. The system of claim 15 further comprising means for setting a voltage for the bus segment based on card location.

18. A method usable in conjunction with configuring a bus segment, the method comprising:
determining location of one or more cards installed on the bus segment; and
configuring the bus segment based on said location.

19. The method of claim 18 wherein configuring the bus segment comprises selecting a clock frequency.

20. The method of claim 18 wherein configuring the bus segment comprises selecting a bus segment voltage.

21. A method usable in conjunction with configuring a bus segment, the method comprising:
determining whether a card is located in a first of two slots coupled to the bus segment; and
if a card is installed in the first slot, preventing the bus segment from operating at a maximum speed permitted by the bus segment.

22. The method of claim 21 further comprising configuring the bus segment to operate at its maximum speed only if the second of the two slots has a card located therein.

23. The method of claim 22 wherein the bus segment is configured to operate at the maximum speed only if the card located in the second slot also is operational at the maximum speed.

24. The method of claim 21 further comprising configuring a voltage level associated with the bus segment based on location of the card.
